(19) United States
(12) Patent Application Publication
(10) Pub. No.: US 2016/0229682 A1
(43) Pub. Date: Aug. 11, 2016

(54) STIRRUP FOR USE WITH STRAPS OF VARIOUS SIZES

(71) Applicant: GARRETT N. FORD, DURANGO, CO (US)

(72) Inventor: GARRETT N. FORD, DURANGO, CO (US)

(21) Appl. No.: 15/017,406

(22) Filed: Feb. 5, 2016

Related U.S. Application Data
(60) Provisional application No. 62/113,248, filed on Feb. 6, 2015.

(51) Int. Cl. B68C 3/00

(52) U.S. Cl. CPC B68C 3/00

(57) ABSTRACT

A stirrup features a hanger that includes multiple slots to accommodate straps of different sizes. Commensurate with conventional straps, the preferred embodiment includes a 1-inch-wide upper slot, a 2-inch-wide intermediate slot, and a 3-inch-wide lower support opening.

### RELATED APPLICATIONS

This application is based on and claims the priority of provisional application Ser. No. 62/113,248 filed Feb. 6, 2015, hereby incorporated by reference.

### BACKGROUND OF THE INVENTION

1. Field of the Invention

The invention relates to stirrups. In particular, it discloses a stirrup that can be used with saddle straps of different sizes.

2. Description of the Prior Art

Stirrups consist of frames or rings for receiving the feet of a horse rider. They are attached to the saddle by means of a strap on each side of the horse and are used as an aid in mounting the horse as well as a support while riding. The style and feel of a stirrup depend upon the preference of the rider and the function of the saddle. Accordingly, stirrups come in different forms. One type of stirrup has a metallic footrest and a metallic hanger for suspending the stirrup from a saddle.

The typical structure of such a metallic stirrup includes a bolt that joins the upper portion of the stirrup and defines the width of the hanger section to which the strap is fastened. A roller is often provided to enclose the bolt and reduce wear on the strap, which is typically a leather component. Because straps come in standard 1-, 2- and 3-inch widths, different bolts and rollers need to be used to fit the size of different straps. This is a problem when a horse is fitted for a different rider with a different-size foot that requires a different-size stirrup (larger, for example). That requires matching the existing strap with a new, larger stirrup, which may not be promptly available. Alternatively, it requires changing also the strap (which usually means changing the saddle) with one commensurate in size with the larger hanger of the new stirrup. In either case, the process is time-consuming and undesirable.

### SUMMARY OF THE INVENTION

The invention lies in a stirrup with a hanger portion that includes multiple openings sized to receive different sizes of conventional straps. For example, a stirrup with three openings with parallel upper surfaces sized 1, 2 and 3 inches, respectively, could accommodate correspondingly sized straps simply by fastening the strap through the appropriate opening.

Additional features and advantages of the invention will be forthcoming from the following detailed description of certain specific embodiments when read in conjunction with the accompanying drawings.

### BRIEF DESCRIPTION OF THE DRAWINGS

FIG. 1 illustrates two conventional stirrups with bolts of different sizes that provide the required width to accommodate a respective strap.

FIG. 2 is an elevational front view of the top portion of the hanger section of a stirrup according to the invention.

FIG. 3 is a perspective view of a stirrup with three openings designed to accommodate three different sizes of strap.

### DESCRIPTION OF THE PREFERRED EMBODIMENTS

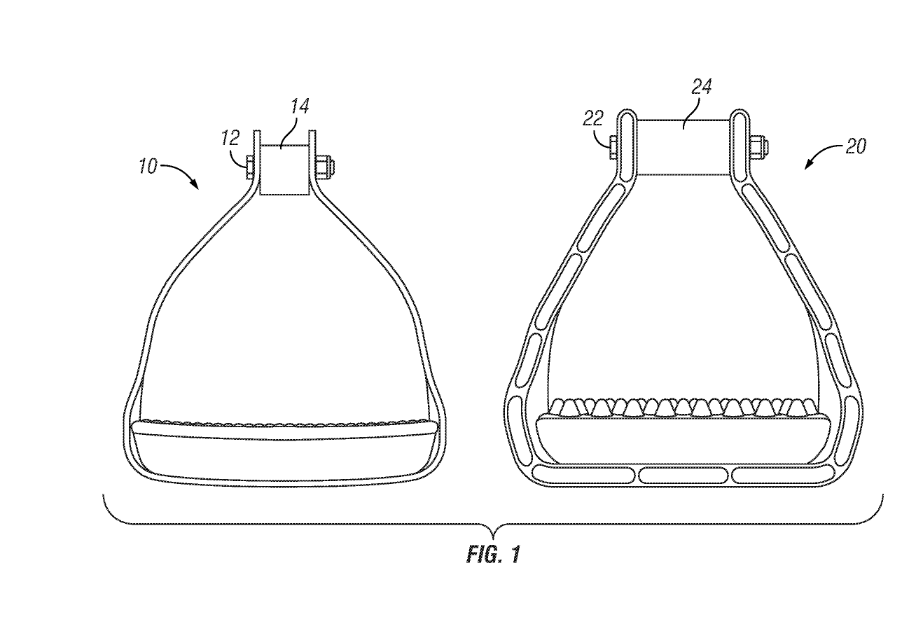

As used herein, the terms opening and slot are used interchangeably to refer to a structure in the hanger portion of a stirrup adapted for receiving a saddle strap threaded therethrough and secured to connect the stirrup to the saddle. Such openings and slots are characterized by an upper edge sized to conform to the width of the strap from which the stirrup hangs. Referring to the figures, the same reference numerals are used throughout to identify the same structural features. In FIG. 1, the numerals 10 and 20 illustrate two prior-art stirrups with bolts 12,22 and corresponding rollers 14,24 that define the width of the hanger portion of the stirrup. The bolts and rollers are selected to conform to the size of the strap for which the stirrup is intended. Fitting such conventional stirrups to a different size strap requires either the use of a different stirrup or the removal of the bolt and roller (if one is present) and their replacement with a bolt/roller combination of appropriate size.

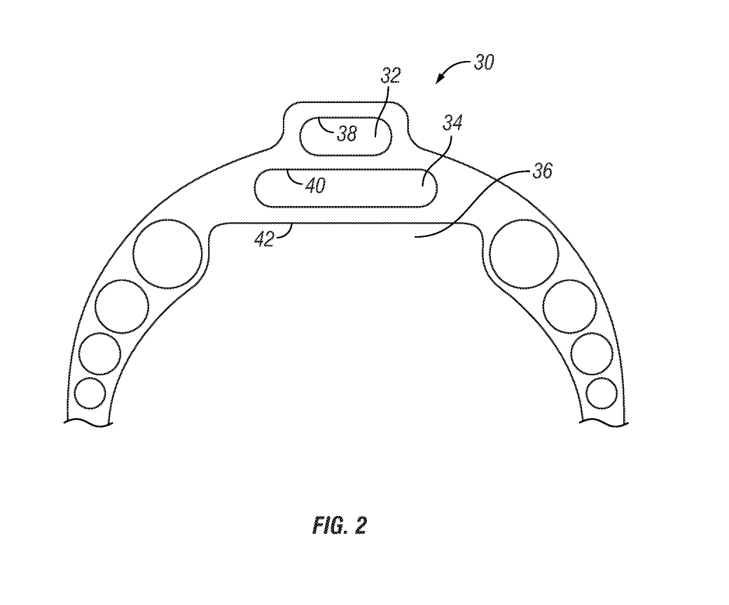

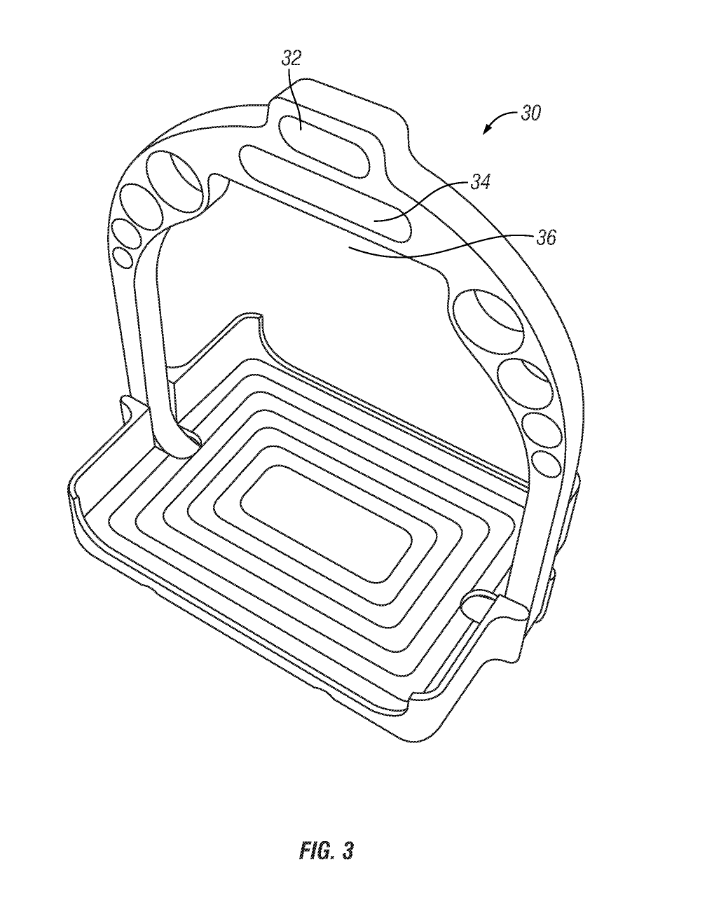

Referring to FIG. 2, it illustrates the concept of the invention incorporated in the top portion of the hanger section of a stirrup 30. The hanger section of the stirrup includes three strap supports in the form of an upper slot 32, an intermediate slot 34, and a lower opening 36, each with a support surface capable of receiving a strap of commensurate width threaded through the hanger. The support surfaces of the slots 32,34 and opening 36 are preferably parallel to one another and aligned vertically in the top portion of the hanger. Advantageously, the support surface 38 of the upper slot 32 is preferably about 1 inch wide, the support surface 40 of the intermediate slot 34 is about 2 inches wide, and the support surface 42 of lower opening 36 is about 3 inches wide, so as to match the three conventional strap widths currently in use in the art. FIG. 3 illustrates the same features in a perspective view of the stirrup 30.

It is understood that the multiple slots and openings of the hanger can be sized in any manner most suitable for coupling with straps of various designs and materials. In addition, many more slots with corresponding width choices could be incorporated in the hanger of the invention by lengthening its top section as necessary to accommodate them. Once threaded through the slot of appropriate size, the strap is folded upward and over any portion of the hanger above the fold, so as to hide it from view and avoid interference from surrounding objects.

While the invention has been shown and described herein with reference to what are believed to be the most practical embodiments, it is recognized that departures can be made within the scope of the invention. Therefore, the invention is not to be limited to the details disclosed herein but is to be accorded the full scope of equivalent articles.

1. A stirrup comprising:
a structure for supporting a human foot, said structure including a hanger portion adapted to receive a saddle strap;
wherein said hanger portion includes multiple openings with respective support surfaces adapted to receive corresponding different sizes of said strap.

2. The stirrup of claim 1, wherein said support surfaces are parallel to one another and aligned vertically in said hanger portion of the stirrup.

3. The stirrup of claim 1, wherein said support surfaces include three support surfaces approximately 1-inch, 2-inches and 3-inches wide, respectively.

4. The stirrup of claim 3, wherein said three support surfaces are parallel to one another and aligned vertically in said hanger portion of the stirrup.

5. The stirrup of claim 1, wherein said multiple openings include an upper slot, an intermediate slot, and a lower opening in the hanger portion of the stirrup.

6. The stirrup of claim 5, wherein said support surfaces in the upper slot, the intermediate slot, and the lower opening in the hanger portion of the stirrup are parallel to one another and aligned vertically.

7. The stirrup of claim 1, wherein said support surfaces in the upper slot, the intermediate slot, and the lower opening are approximately 1-inch, 2-inches and 3-inches wide, respectively.
